(19) United States
(12) Patent Application Publication
(10) Pub. No.: US 2015/0133303 A1
(43) Pub. Date: May 14, 2015

(54) Electrical Generator

(71) Applicant: Paul M. Gregory, Aurora, CO (US)

(72) Inventor: Paul M. Gregory, Aurora, CO (US)

(73) Assignee: TransLife Energy Solutions, Inc., Denver, CO (US)

(21) Appl. No.: 14/144,188

(22) Filed: Dec. 30, 2013

Related U.S. Application Data
(60) Provisional application No. 61/747,979, filed on Dec. 31, 2012.

(51) Int. Cl. H02K 1/24; H02K 55/00; H02K 9/20

(52) U.S. Cl. CPC H02K 1/246; H02K 9/20; H02K 55/00
USPC 505/163; 310/168; 310/55; 505/166

(57) ABSTRACT

An electrical generator is provided. The generator comprises an outer stator coil comprising an input terminals in the outer stator coil, the outer stator coil adapted to provide an electromagnetic field in response to an excitation current applied to the input terminals; a plurality of inner pick-up coils coupled to an electrical output of the electrical generator; and a rotating cage comprising a plurality of shielding members and openings, the plurality of shielding members at least partially shielding the plurality of inner pick-up coils from an electromagnetic field generated by the outer stator coil while the rotating cage is rotating

### CROSS-REFERENCE OF RELATED APPLICATIONS

This application claims the benefit of U.S. provisional application No. 61/747,979, filed 31 Dec. 2012, which application, including but not limited to all appendices, drawings and other material filed therewith, is hereby incorporated by reference as though fully set forth herein.

### BACKGROUND

a. Field

The instant invention relates to an electrical generator. In particular, the instant invention relates to an electrical generator comprising a rotating cage for varying an electric field between a field generating coil and a pick up coil.

b. Background

A standard alternating current (AC) electrical generator includes a fixed exterior stator and a rotating rotor on the interior. The rotor often includes pick up coils. As a coil is turned in a magnetic field, the magnetic field exerts a magnetic field on charges in the moving conductor of the coil to generate a voltage (a motional electromotive force (EMF)) in both sides of the coil. Since the component of the velocity perpendicular to the magnetic field changes sinusoidally with the rotation, the generated voltage is sinusoidal or AC. This process can be described in terms of Faraday's law when the rotation of the coil continually changes the magnetic flux through the coil and therefore generates a voltage.

### BRIEF SUMMARY

In one implementation, an electrical generator is provided comprising: an outer stator coil comprising an input terminals in the outer stator coil, the outer stator coil adapted to provide an electromagnetic field in response to an excitation current applied to the input terminals; a plurality of inner pick-up coils coupled to an electrical output of the electrical generator; and a rotating cage comprising a plurality of shielding members and openings, the plurality of shielding members at least partially shielding the plurality of inner pick-up coils from an electromagnetic field generated by the outer stator coil while the rotating cage is rotating.

In another implementation another electrical generator is provided comprising: an outer stator coil comprising at least one first superconductive material, the outer stator coil comprising an input terminals, the outer stator coil adapted to provide an electromagnetic field in response to an excitation current applied to the input terminals; a plurality of inner pick-up coils coupled to an electrical output of the electrical generator; a rotating cage comprising at least one second superconductive material, the rotating cage further comprising a plurality of shielding members and openings, the plurality of shielding members at least partially shielding the plurality of inner pick-up coils from an electromagnetic field generated by the outer stator coil while the rotating cage is rotating; and a coolant system for reducing an operating temperature of at least the outer stator coil and the rotating cage, wherein the outer stator coil and the rotating cage each comprise at least one superconductive material, the coolant system is adapted to reduce the operating temperature to or below a critical temperature of the at least one superconductive materials.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 shows an example implementation of an electrical generator.

FIG. 2 shows an exploded view of an example superconductor-based electrical generator.

FIG. 3 shows a perspective view of the example superconductor-based electrical generator shown in FIG. 2.

FIG. 4 shows an example implementation of an electrical generator in an example distributed electrical power system.

FIG. 5 shows another example implementation of an electrical generator in an example distributed electrical power system.

### DETAILED DESCRIPTION

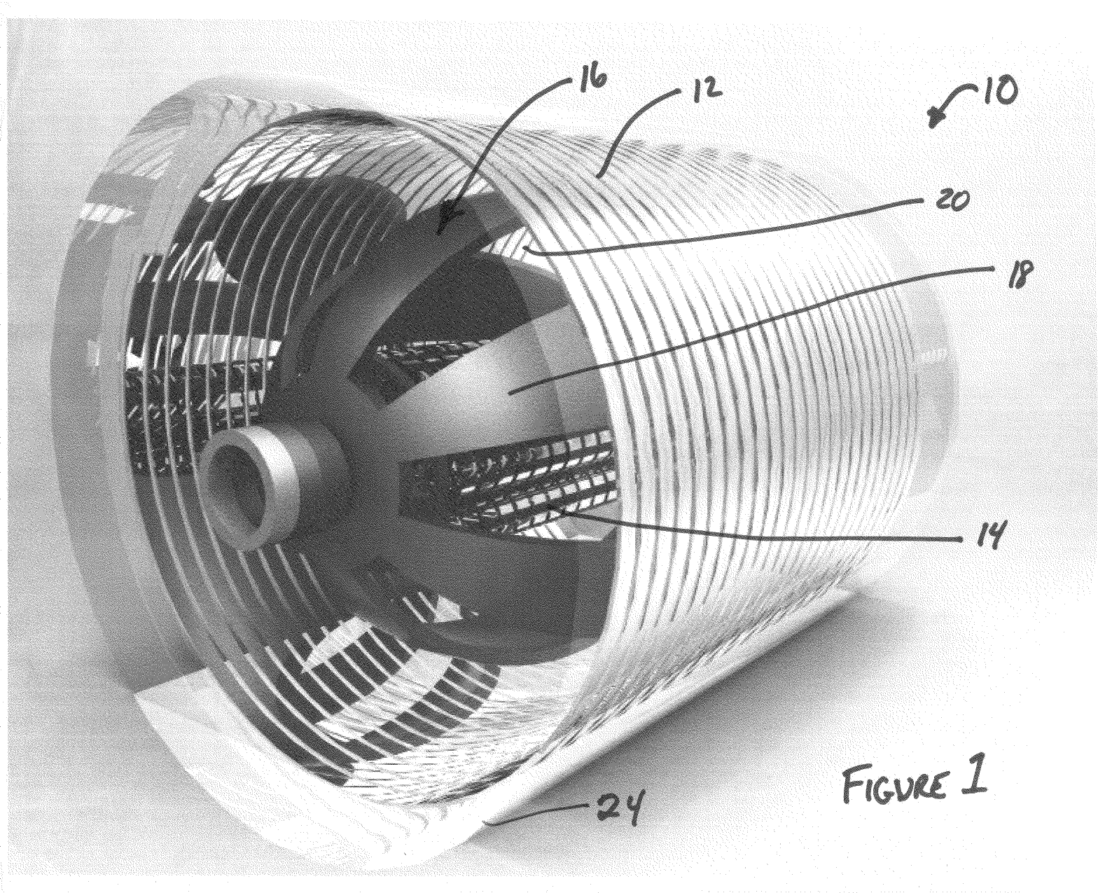

FIG. 1 shows an example implementation of an electrical generator 10. In this implementation, the electrical generator 10 comprises an outer stator coil 12, a plurality of inner “fixed rotor” pick up coils 14 and a rotating cage 16 disposed between the outer stator coil 12 and the plurality of inner “fixed rotor” pick-up coils 14.

The outer stator coil 12 is excited with a DC current to provide an electromagnetic field inside the electrical generator 10. The DC current may be provided, for example, by any number of current sources, such as a DC current source or rectified AC current source. For example, the current source may include one or more of the following examples: a renewable energy source, such as one or more solar panel, wind turbine, geothermal source or the like, a battery, a capacitor, such as an ultracapacitor or traditional capacitor, or a conventional current supply.

The plurality of inner “fixed rotor” pick-up coils are electromagnetically coupled with the outer stator coil 12 via the electromagnetic field, which induces a voltage in the pick-up coils 14. The rotating cage 16 comprises a plurality of shielding members 18 and a plurality of openings 20 disposed between the shielding members 18. As the rotating cage 16 rotates within the electromagnetic field generated by the outer stator coil 12, the alternating shielding members 18 and openings 20 of the rotating cage 16 provide a shuttering effect in which the electromagnetic field at the pick-up coils is alternated.

In the particular implementation shown in FIG. 1, for example, the rotating cage comprises a generally rhombus shape comprising six individual shielding members 18 and six individual openings 20. Although the rhombus shape rotating cage is shown, other shapes are also possible, such as but not limited to a cylindrical, spherical or other shaped rotating cage. In addition, the use of six shielding members 18 and openings 20 is also merely exemplary; any number of shielding members and openings may be used.

The rotating cage 16, for example, may be rotated by any motor. Depending on the number of shielding members 18 and openings 20 as well as the number of inner pick-up coils 14, the frequency of the output voltage may be determined by the rotational speed of the rotating cage turning within the electromagnetic field generated by the outer stator coil 12 of the electrical generator 10. Where the rotating cage 16 of the electrical generator 10 has six shielding members 18 and six openings 20 and the pick-up coils has six coils, the rotating cage 16 may be rotated at 600 RPM to obtain an output voltage of 60 Hz. However, the speed or design of the generator may be changed to provide an alternative output frequency.

The plurality of inner pick-up coils 18 are coupled to an output 22 of the electrical generator 10. When coupled to a load, the voltage induced in the plurality of inner pick-up coils 18 provides current to power the load.

The electrical generator 10, in some implementations, further comprises a coolant system for keeping the elements of the electrical generator 10 cooled during operation of the generator 10. In one particular implementation, the coolant system comprises an outer cryogenic container 24 that, in this particular implementation, comprises a sleeve that extends beyond distal and proximal ends of the electrical generator 10. Although the cryogenic container 24 is shown as a sleeve completely encompassing the outer stator coil 12, the plurality of fixed pick-up coils 14 and the rotating cage, the cryogenic container 24 may be provided in any other configuration that is effective to cool the one or more superconductive elements of the electrical generator 10.

In superconductor-based example implementations, for example, a cryogenic container 24 may be used to cool one or more components of the generator to an operating temperature at or below their critical temperature. The cryogenic container 24, for example, may house a coolant (e.g. liquid nitrogen or liquid helium) for reducing the temperature of any superconductive element of the electrical generator 10 to or below its critical temperature at which it operates in an efficient manner. Although various embodiments are discussed with respect to superconductor elements and cooling an operating temperature of the device to a temperature at or below a critical temperature of superconductor materials, one or ordinary skill in the art would readily recognize that the electrical generators described herein may also be constructed of standard components/materials without superconductor materials. Thus, cooling, if any, need not be to such a critical temperature in these implementations.

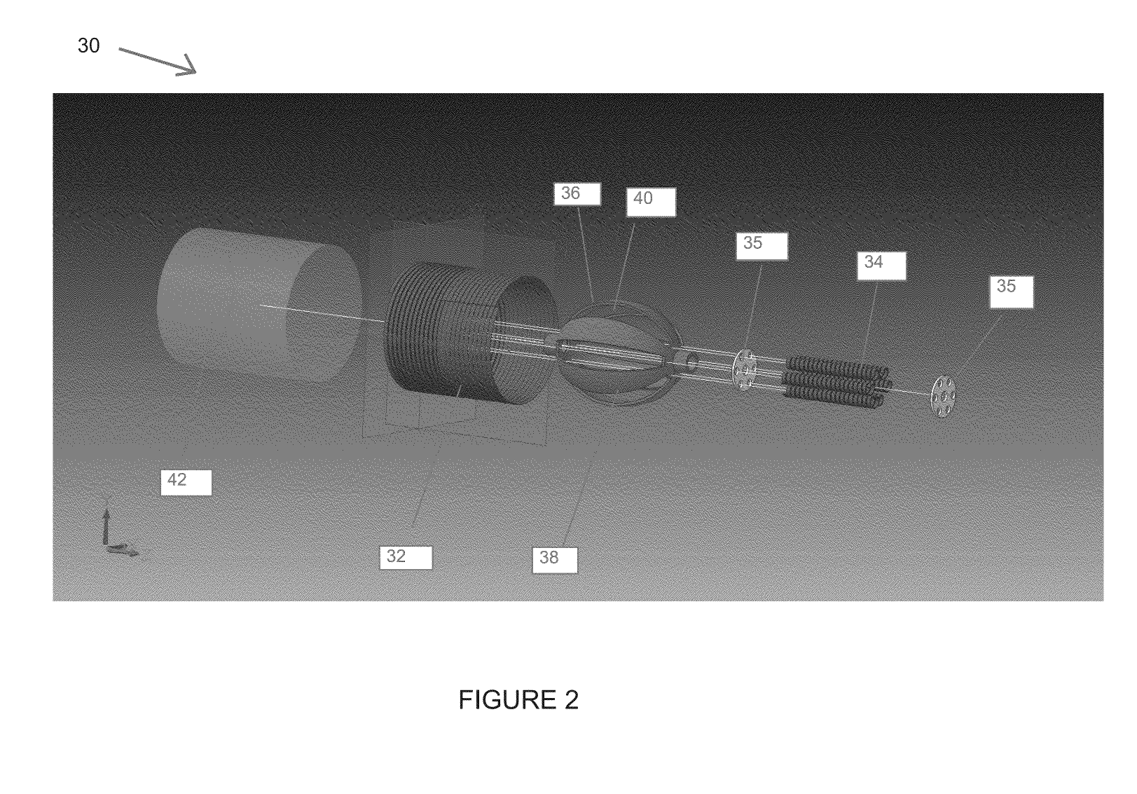

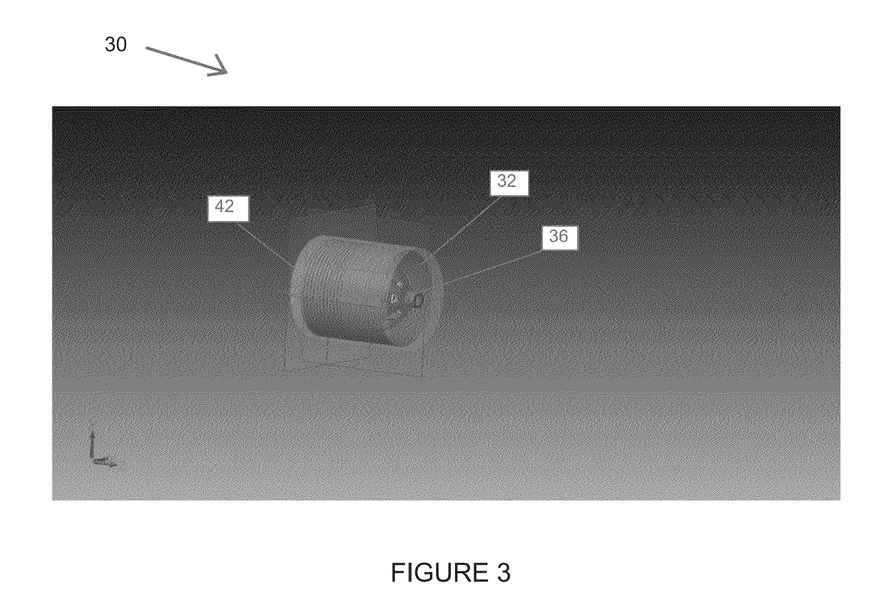

FIGS. 2 and 3 show an exploded view of a superconductor-based electrical generator 30 (FIG. 2) and a perspective view of the superconductor-based electrical generator 30 (FIG. 3). In the particular implementation shown in FIGS. 2 and 3, for example, one or more components of the electrical generator 30 may comprise one or more superconductive elements in its construction.

Similar to the generator described above with respect to FIG. 1, the super-conductor-based electrical generator 30 shown in FIGS. 2 and 3 comprises an outer stator coil 32, a plurality of inner “fixed rotor” pick up coils 34 and a rotating cage 36 disposed between the outer stator coil 32 and the plurality of inner “fixed rotor” pick-up coils 34. In various implementations of the superconductor-based electrical generator 30 shown in FIGS. 2 and 3, elements such as the outer stator coil and the rotating cage may comprise one or more superconductive material that, during operation of the generator, is cooled to or below its critical temperature for imparting superconductive properties to the material.

The outer stator coil 32 is excited with a DC current to provide an electromagnetic field inside the electrical generator 30 as described above with respect to FIG. 1. Where the outer stator coil 32 comprises one or more superconductive material, an initial current may be applied to the outer stator coil 32 until the coil reaches its critical temperature or below and then a current source may be removed and the coil placed in a loop such that the excitation current continues to flow through a closed loop current. In this implementation, due to the miniscule resistance of the superconductive outer stator coil 32, the excitation current may continue to flow with no or almost no loss in amplitude as long as the temperature is maintained at or below the critical temperature of the superconductive material used in the outer stator coil 32.

In one implementation, for example, a high temperature superconductive material such as YBCO may be used to form a continuous superconductive wire having a critical temperature of approximately −160° C. that can operate efficiently, for example, in a range from about −160° C. to about −250° C. In this particular implementation, for example, by reducing the operating temperature of the outer stator coil 32 below the critical temperature of about −160° C. towards about −250° C., a higher current level may be introduced into the outer stator coil 32 to provide an increased electromagnetic field in the electrical generator 30. Increasing the electromagnetic field, in turn, allows the electrical generator 32 to provide a greater output power. In some implementations, for example, cooling the superconductive outer stator coil 32 below its critical temperature may provide a multiple output effect in which the increase in output power is greater than a corresponding increase in input power provided to the outer stator coil 32.

The plurality of inner “fixed rotor” pick-up coils 34 are electromagnetically coupled with the outer stator coil 12 via the electromagnetic field, which induces a voltage in the pick-up coils 14. The inner pick-up coils 34, for example, may comprise copper and/or another conductive material and are coupled to an electrical output of the electrical generator 30. In this implementation, for example, six inner pick-up coils are mounted via mounting plates 35. Electrical connections to the inner pick-up coils 34 provide an output current to a load when the electrical generator 30 is coupled to the load.

The rotating cage 36 comprises a plurality of shielding members 38 and a plurality of openings 40 disposed between the shielding members 38. As the rotating cage 36 rotates within the electromagnetic field generated by the outer stator coil 32, the alternating shielding members 38 and openings 40 of the rotating cage 36 provide a shuttering effect in which the electromagnetic field at the pick-up coils is alternated. In this implementation, the rotating cage 36 comprises one or more superconductive materials. The rotating cage 36, for example, may comprise a cage formed using a superconductive material, such as YBCO, and/or may include one or more coatings comprising a superconductive material.

The Meissner effect of superconductivity results in the complete expulsion of magnetic flux from penetrating the surface of a superconductor at or below the critical temperature of the superconductor. Below a critical field level, which varies with temperature, the Meissner effect of a superconductor works to expel the magnetic flux from a superconductor. Beyond that magnetic field, however, the magnetic field penetrates the superconductive material and superconductivity is lost. Appendix 1 to U.S. provisional application 61/747,979, filed 31 Dec. 2012 (incorporated herein by reference in its entirety and to which priority is claimed in the present application) provides properties of superconductivity, such as the Meissner effect and zero resistivity, identifies various types of superconductor materials and transition temperatures for superconductor materials. Appendix 2 to U.S. provisional application 61/747,979, filed 31 Dec. 2012 (incorporated herein by reference in its entirety and to which priority is claimed in the present application) provides further background into shielding and other effects of superconductive materials.

Thus, where the rotating cage 36 comprises one or more superconductive material and the operating temperature of the electrical generator 30 at the rotating cage 36 is at or below the critical temperature of the superconductive material, shielding members 38 of the rotating cage 36 can provide a perfect shield (or at least a very highly efficient shield) to block a portion of the electromagnetic field generated by the outer stator coil 32 from reaching the inner pick-up coils 34.

In one example implementation, the rotating cage 36 may comprise clay baked into a ceramic piece (e.g., in the shape of rhombus) and coated with an exterior layer of YBCO powder to cover its entire exterior surface. The non-metallic cage can act as a theoretically perfect “shield” utilizing the Meissner effect to pass between the exterior coil and the internal pick-up coils (e.g., copper). With the alternating opening and closed slots, the cage will effectively open and close to the pick-up coils inside, causing a rise and fall of the induced flux, and generating an AC current on the coils.

Since the rotating cage 36, in this implementation, is made of non-metallic materials, an external drive motor may be effectively just a timing motor and does not need to provide the relatively high level of torque required by conventional generators.

As described above with respect to FIG. 1, the rotational speed of the rotating cage 36 may be adjusted to provide varying output frequencies for the electrical generator 30.

In the implementation shown in FIGS. 2 and 3, the rotating cage comprises a generally rhombus shape comprising six individual shielding members 38 and six individual openings 40. Although the rhombus shape rotating cage is shown, other shapes are also possible, such as but not limited to a cylindrical, spherical or other shaped rotating cage. In addition, the use of six shielding members 38 and openings 40 is also merely exemplary; any number of shielding members and openings may be used.

The plurality of inner pick-up coils 38 are coupled to an output 42 of the electrical generator 30. When coupled to a load, the voltage induced in the plurality of inner pick-up coils 38 provides current to power the load.

As shown in FIGS. 2 and 3 the superconductor-based electrical generator 30 further comprises a coolant system for keeping the superconductor elements of the electrical generator 30 at or below their critical temperature during operation of the generator 30. In this particular implementation, the coolant system comprises an outer cryogenic container 42 that, in this particular implementation, comprises a sleeve that extends beyond distal and proximal ends of the electrical generator 30. Although the cryogenic container 42 is shown as a sleeve completely encompassing the outer stator coil 32, the plurality of fixed pick-up coils 34 and the rotating cage, the cryogenic container 42 may be provided in any other configuration that is effective to cool the one or more superconductive elements of the electrical generator 30.

The cryogenic container 42, for example, may house a coolant (e.g. liquid nitrogen or liquid helium) for reducing the temperature of any superconductive element of the electrical generator 30 to or below its critical temperature at which it operates in an efficient manner.

Although YBCO is described as an example superconductive material that may be used in various components of a superconductor-based electrical generator, any number of superconductive materials may be used. HTS, for example, has a critical temperature of about −183° C. and may be operated in a range from about −183° C. to about −253° C.

In addition, superconductors can be grouped as High Temperature Superconductors (HTS) or Low Temperature Superconductors (LTS) that have critical temperatures relatively lower than HTS materials. Although cooling HTS superconductive materials to or below their critical temperature is relatively easier than cooling LTS superconductive materials, either HTS or LTS superconductive materials may be used in an electrical generator 30.

Appendix 3 to U.S. provisional application 61/747,979, filed 31 Dec. 2012 (incorporated herein by reference in its entirety and to which priority is claimed in the present application) includes a list of example HTS materials that may be used in the present design. These are merely examples of possible superconductive materials that may be used in superconductive electrical generator implementations. As described above, HTS or LTS may be used in various implementations.

In addition, pressure may be applied to the coolant in the coolant system to lower the temperature of the coolant system of the generator. For example, liquid nitrogen or helium may be pumped and condensed in a cryogenic container to lower the operating temperature of the generator 30, which in turn may allow for increased input current flowing through the outer stator coil 32 and increasing the flux in the electromagnetic field of the generator. Similarly, where the inner pick-up coils are made from high grade copper, the efficiency of the coils may be increased and the resistance of those coils decreased as the operating temperature is reduced.

In some implementations, a vacuum may be drawn within a coolant system of the electrical generator to increase the cooling efficiency of the coolant system. For example, a vacuum may be drawn inside a cryogenic container housing all or part of the electrical generator.

In some implementations, for example, a drive shaft for the rotating cave may extend into the cryogenic container from outside the controlled temperature environment. In this particular implementation, for example, any heat generated by mechanical friction (e.g., bearings) may be dissipated outside of the cryogenic container and limit the heating effect inside the cryogenic container. In other implementations, efficient bearing or other frictional devices, such as air, liquid or other bearings or other components may be used, such as inside a cryogenic container, to reduce heat being generated by mechanical forces, such as friction, within a temperature controlled environment of the generator.

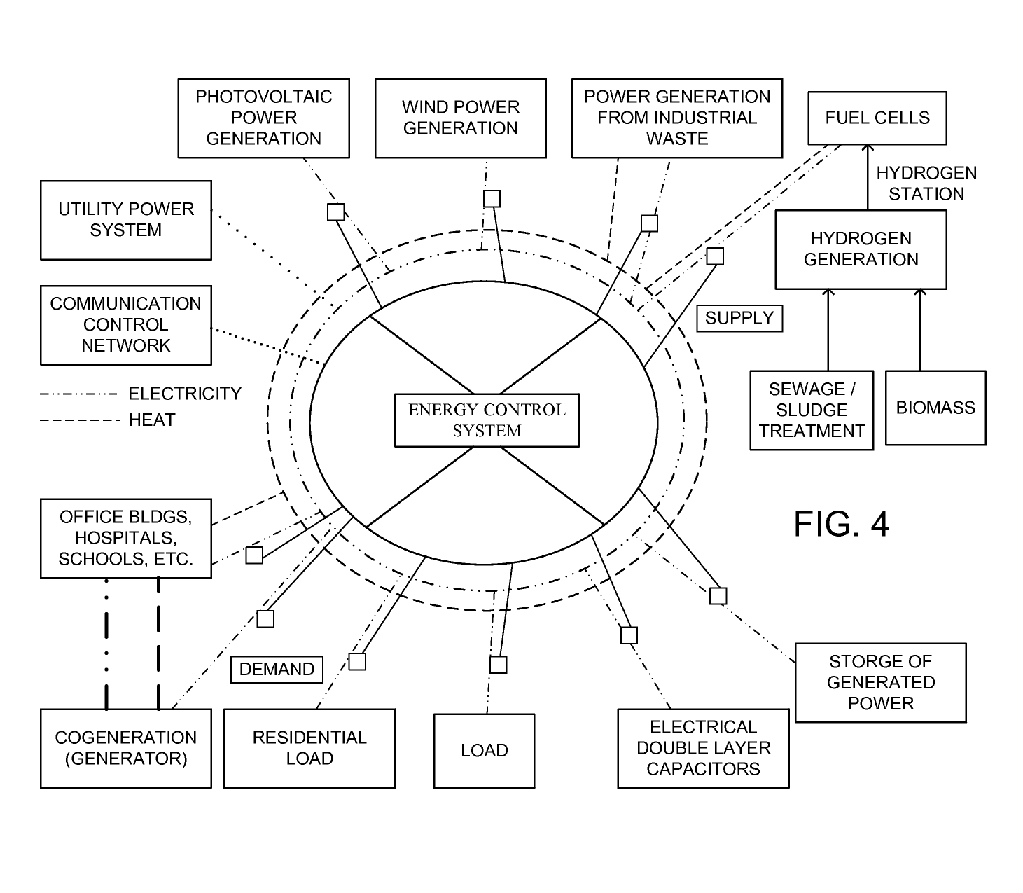

FIG. 4 shows an example implementation of an electrical generator in an example distributed electrical power system. In this implementation, the electrical generator is shown connected to a microturbine and is connected to the electrical power grid, such as via a converter. The generator could be connected to the distributed electrical power system in other locations as known in the art.

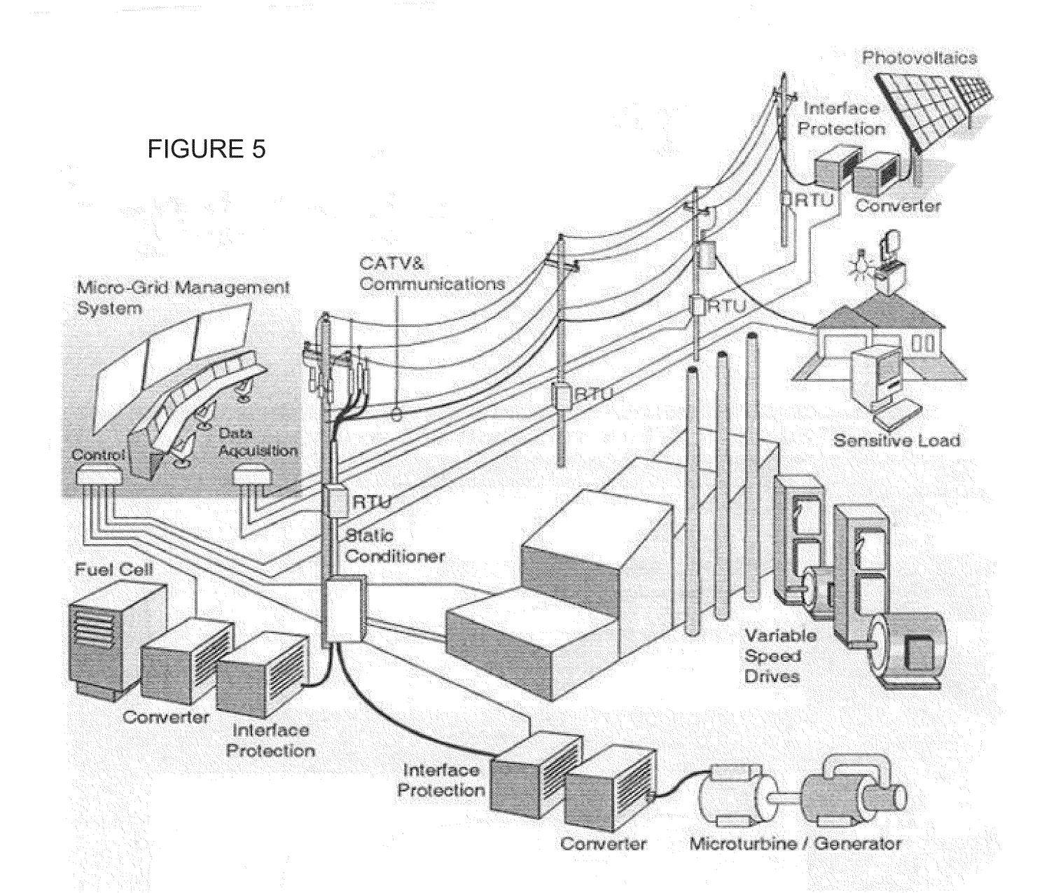

FIG. 5 shows an alternative distributed electrical power system. In this implementation, the electrical generator may be connected to the distributed electrical power system in various configurations. In one example, the electrical generator is identified with the “Cogeneration” to provide electrical power into the system.

Although multiple embodiments of this invention have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims. Docket No.

What is claimed is:

1. An electrical generator comprising:
an outer stator coil comprising an input terminals in the outer stator coil, the outer stator coil adapted to provide an electromagnetic field in response to an excitation current applied to the input terminals;
a plurality of inner pick-up coils coupled to an electrical output of the electrical generator; and
a rotating cage comprising a plurality of shielding members and openings, the plurality of shielding members at least partially shielding the plurality of inner pick-up coils from an electromagnetic field generated by the outer stator coil while the rotating cage is rotating.

2. The electrical generator of claim 1 wherein the outer stator coil comprises at least one superconductive material.

3. The electrical generator of claim 1 wherein the rotating cage is a non-magnetic rotating cage.

4. The electrical generator of claim 1 wherein the rotating cage comprises at least one superconductive material.

5. The electrical generator of claim 4 wherein the at least one superconductive material shields an electromagnetic flux from the rotating cage at or below a critical temperature of the superconductive material.

6. The electrical generator of claim 1 wherein the electrical generator comprises a coolant system.

7. The electrical generator of claim 6 wherein the coolant system comprises a cryogenic container.

8. The electrical generator of claim 7 wherein the cryogenic container comprises a sleeve extending around a perimeter of the outer stator coil.

9. The electrical generator of claim 6 wherein the coolant system comprises a liquid coolant under pressure.

10. An electrical generator comprising:
an outer stator coil comprising at least one first superconductive material, the outer stator coil comprising an input terminals, the outer stator coil adapted to provide an electromagnetic field in response to an excitation current applied to the input terminals;
a plurality of inner pick-up coils coupled to an electrical output of the electrical generator;
a rotating cage comprising at least one second superconductive material, the rotating cage further comprising a plurality of shielding members and openings, the plurality of shielding members at least partially shielding the plurality of inner pick-up coils from an electromagnetic field generated by the outer stator coil while the rotating cage is rotating; and
a coolant system for reducing an operating temperature of at least the outer stator coil and the rotating cage,
wherein the outer stator coil and the rotating cage each comprise at least one superconductive material, the coolant system is adapted to reduce the operating temperature to or below a critical temperature of the at least one superconductive materials.

11. The electrical generator of claim 10 wherein the outer stator coil is adapted to receive a start-up current from a current source via the input terminals, and the input terminals are adapted to be switched from the current source to a closed loop after the start-up current is established in the outer stator coils.

12. The electrical generator of claim 11 wherein the input terminals are adapted to be switched to a closed loop removing the current source from the generator when the operating temperature is reduced to or below a critical temperature of the at least one first superconductive material of the outer stator coil.

13. The electrical generator of claim 10 wherein the at least one first and second superconductive materials comprise a least one high temperature superconductive (HTS) material.

14. The electrical generator of claim 10 wherein the at least one first and second superconductive materials comprise a least one low temperature superconductive (LTS) material.

15. The electrical generator of claim 10 wherein the at least one first and second superconductive materials comprise the same superconductive materials.

16. The electrical generator of claim 10 wherein the plurality of inner pick-up coils comprise copper.

17. The electrical generator of claim 10 wherein the coolant system comprises a cryogenic container.

18. The electrical generator of claim 10 wherein the coolant system comprises liquid nitrogen.

19. The electrical generator of claim 10 wherein the coolant system liquid helium.

20. The electrical generator of claim 10 wherein the coolant system is adapted to cool the outer stator coil to an operating temperature below its critical temperature to provide a multiple output effect in which an increase in output power is greater than a corresponding increase in input power provided to the outer stator coil.
